(19) United States
(12) Patent Application Publication
(10) Pub. No.: US 2026/0334728 A1
(43) Pub. Date: Oct. 29, 2026

(54) APPLIANCE FOR GRINDING AND FILLING A FILTER TO BE CONNECTED TO A CUP COFFEE DISPENSING MACHINE WITH COFFEE POWDER

(71) Applicant: Ambrodesign Sas di Marco Ambrosini & C., Verona (VR) (IT)

(72) Inventor: Marco AMBROSINI, Verona (VR) (IT)

(73) Assignees: Ambrodesign Sas di Marco Ambrosini & C., Verona (VR) (IT); Ambrodesign Sas di Marco Ambrosini & C., Verona (VR) (IT)

(21) Appl. No.: 19/116,071

(22) PCT Filed: Sep. 27, 2023
(86) PCT No.: PCT/IB2023/059612

§ 371 Date: Mar. 27, 2025

(30) Foreign Application Priority Data
Sep. 29, 2022 (IT) 102022000020082

(51) Int. Cl. A47J 42/40; A47J 31/06; A47J 42/16; A47J 42/20; A47J 42/44; A47J 42/46; A47J 42/50

(52) U.S. Cl. CPC A47J 42/40; A47J 31/0663; A47J 42/16; A47J 42/20; A47J 42/44; A47J 42/46; A47J 42/50

(57) ABSTRACT

The appliance (1) for grinding and filling with coffee powder a filter to be connected to a cup coffee dispensing machine comprises:

a holding frame (2);

a hopper (3);

a grinding assembly (4) comprising a first grindstone (4a) and a second grindstone (4b), at least one of the grindstones (4a, 4b) rotating around a vertical axis (X);

a first casing (19) substantially coaxial to the vertical axis (X);

a second casing (20) substantially coaxial to the vertical axis (X), wherein the first casing (19) and the second casing (20) are spaced apart from each other by a gap defining an annular chamber (10) adapted to receive coffee powder (P) and to convey it to a filter (13);
actuating means (30) arranged within the second casing (20) and adapted to move a presser (15) along the vertical axis (X) to press the coffee powder (P) collected in the filter (13).

### TECHNICAL FIELD

The present invention relates to an appliance for grinding and filling with coffee powder a filter to be connected to a cup coffee dispensing machine.

### BACKGROUND ART

The problem of coffee preparation with espresso machines is well known, particularly but not exclusively in the catering industry.

In “on-demand” coffee grindstones of known type, the user inserts coffee beans into a special hopper and pre-sets upstream, through special manual or electronic devices also of known type, the parameters for obtaining coffee according to the desired grain size.

When this operation is completed, the user starts the machine, which grinds and conveys the coffee powder into a special filter and then presses it manually or through a remote electric presser.

This operation is, especially for catering service workers, rather laborious, as it must be repeated numerous times throughout the day.

To overcome this drawback, cup coffee machines have been designed which comprise actuators built into the machine itself for pressing coffee powder.

These machines illustrated, e.g., in U.S. Pat. No. 6,095,032, involve the pressing of ground coffee and conveyed through a special spout towards a filter where the coffee powder is then pressed through a special presser moved by means of actuator means.

However, such machines of known type do have some drawbacks.

First of all, coffee dispensing is uneven due to the fact that ground coffee is conveyed by gravity through a spout/channel arranged sideways to the filter underneath.

This results in uneven distribution of freshly ground coffee powder on the filter.

The uneven distribution of coffee on the filter also results in a subsequent pressing of the coffee that is equally uneven and a consequent suboptimal quality of the coffee dispensed in the cup, once the filled filter is inserted into the machine for cup coffee dispensing.

The present invention aims to eliminate the aforementioned drawbacks.

### DESCRIPTION OF THE INVENTION

Specifically, it is the object of the present invention to make an appliance for grinding and filling with coffee powder a filter to be connected to a cup coffee dispensing machine, wherein the freshly ground coffee powder is evenly distributed over the filter, so that it is then evenly pressed.

A further object of the present invention is to make an appliance for grinding and filling with coffee powder a filter to be connected to a cup coffee dispensing machine which avoids the user from pressing the coffee powder manually or with the help of remote automatic pressers.

The aforementioned objects are achieved by an appliance for grinding and filling with coffee powder a filter to be connected to a cup coffee dispensing machine, according to claim 1.

Further characteristics of the appliance for grinding and filling with coffee powder a filter to be connected to a cup coffee dispensing machine according to the invention are the subject of the dependent claims.

Advantageously, the appliance for grinding and filling with coffee powder a filter to be connected to a cup coffee dispensing machine according to the invention allows freshly ground coffee powder to accumulate evenly over the entire circular periphery of the filter underneath, then allowing even pressing of the powder itself over the entire surface of the filter that collects it.

Still advantageously, the appliance for grinding and filling with coffee powder a filter to be connected to a cup coffee dispensing machine according to the invention provides that the grinding assembly and the presser are aligned according to a single axis, which allows the grinding and pressing of the ground coffee to be operated in a single operation, thus achieving a process carried out more quickly and optimally.

Whereas in the known type of appliances the outflow of freshly ground coffee powder occurred through a spout/channel arranged on the side wall of the chamber containing the grindstones, towards the filter or manual dispenser underneath, in the appliance according to the invention, the outflow of coffee powder from the grinding assembly occurs radially and 360°, in a continuous and even manner, and the coffee powder is conveyed by gravity through an annular chamber, conveniently provided with a conical-shaped lower end, as far as the inside of the filter underneath.

Still advantageously, the appliance according to the invention is more compact than the appliances of known type.

### BRIEF DESCRIPTION OF THE DRAWINGS

Other characteristics and advantages of the present invention will become more apparent from the description of a preferred, but not exclusive, embodiment of an appliance for grinding and filling with coffee powder a filter to be connected to a cup coffee dispensing machine, illustrated by way of an indicative, yet non-limiting example in the accompanying tables of drawings in which:

FIG. 1 is an axonometric view of the appliance according to the invention;

FIG. 2 is an exploded view of the appliance according to the invention;

FIG. 3 is a longitudinal sectional view of the appliance according to the invention;

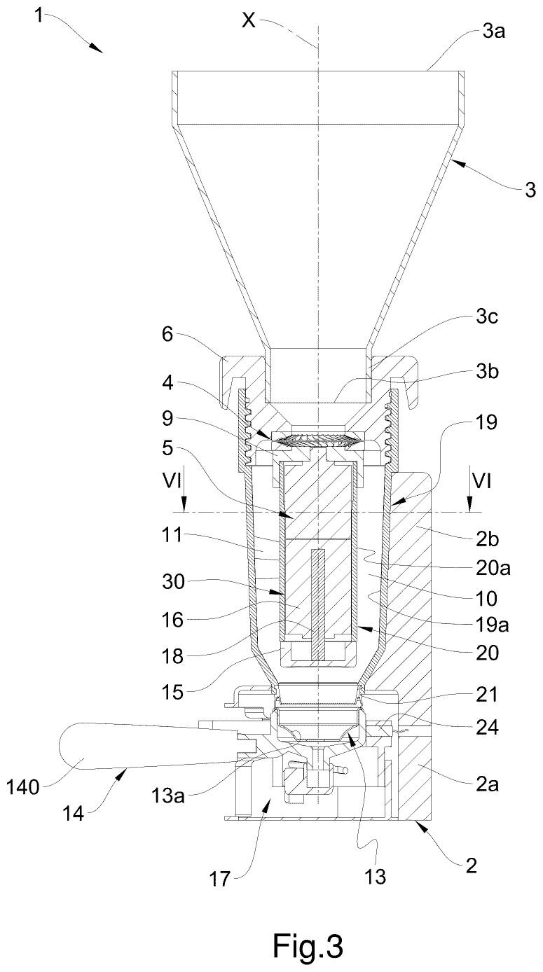

FIG. 4 is an enlarged scale and longitudinal sectional view of a detail from FIG. 3;

FIG. 5 is an enlarged scale and longitudinal sectional view of the detail from FIG. 4, in a different operational configuration;

FIG. 6 is an axonometric view of the appliance according to the invention cut along the VI-VI plane of FIG. 3.

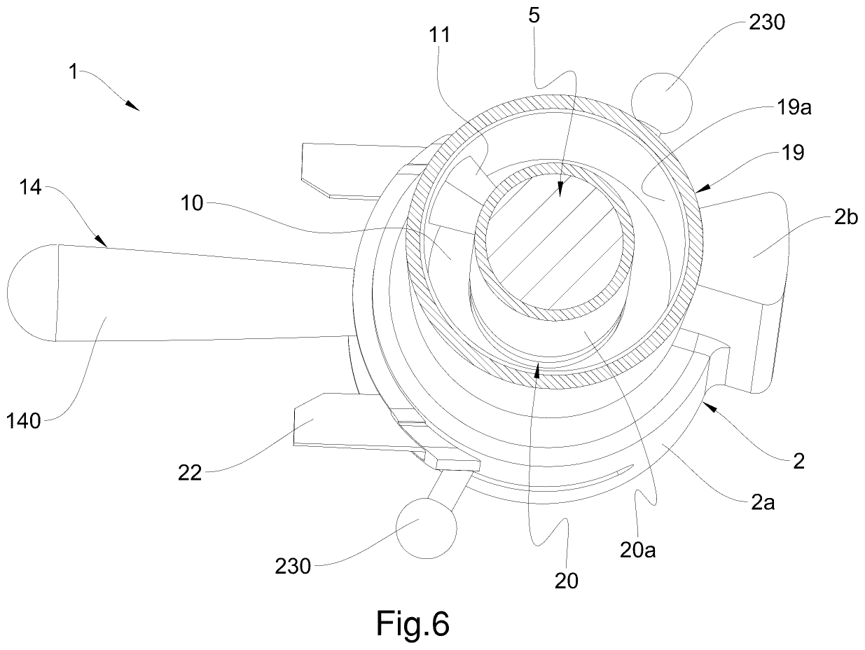

With particular reference to these figures, reference numeral 1 globally denotes an appliance for grinding and filling with coffee powder a filter to be connected to a cup coffee dispensing machine.

The appliance 1, in particular, is intended to grind coffee beans and to fill a filter 13, fitted into a filter holder 14, wherein the filter 13 and the relevant filter holder 14 are of a type known in itself and connectable to a coffee machine, which is also of the traditional type and not covered by the present invention.

Henceforth in the following description, the term “casing” will mean a molded enclosure intended to contain and/or to protect the appliance components according to the invention.

The appliance 1 comprises a holding frame 2 and a hopper 3 arranged superiorly to the holding frame 2.

Advantageously, the holding frame 2 comprises a base 2a from which a supporting pin 2b rises.

The hopper 3 is provided, at one end, with an inlet port 3a for loading coffee beans and, at the opposite end, with a discharge port 3b for ejecting the coffee beans.

In addition, the appliance 1 comprises a grinding assembly 4 arranged inferiorly to the hopper 3 and in communication with the discharge port 3b of the hopper itself.

In turn, the grinding assembly 4 comprises a first grindstone 4a and a second grindstone 4b opposite each other, wherein at least one of the grindstones 4a, 4b rotates around a vertical axis X by means of a first motor 5.

In the particular embodiment shown in the figures, the first grindstone 4a is fixed while the second grindstone 4b is movable by means of the first motor 5; for this reason, in the remainder of this disclosure, the first grindstone 4a and the second grindstone 4b may also be called fixed grindstone 4a and movable grindstone 4b, respectively.

Alternative embodiments cannot however be ruled out wherein both grindstones 4a and 4b are movable, e.g., counter-rotating (i.e., one rotating clockwise and the other rotating counterclockwise).

The grinding assembly 4 is configured to reduce coffee beans to powder according to a grain size preset by the operator. This pre-setting of the grain size is done by adjusting the distance of the fixed grindstone 4a from the movable grindstone 4b by means of a ring nut 6.

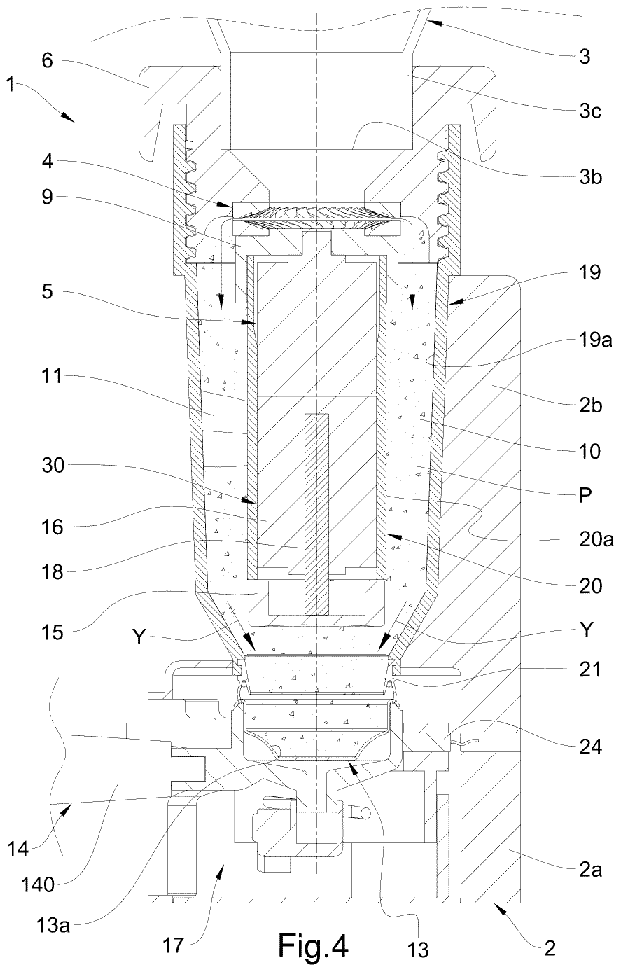

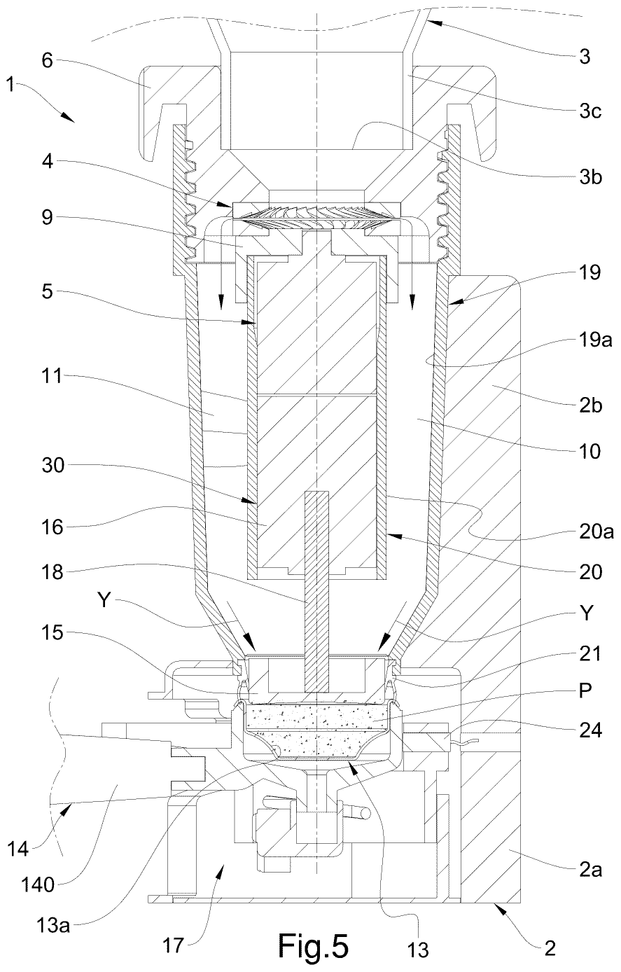

By manually turning the ring nut 6 so as to move the fixed grindstone 4a closer to the movable grindstone 4b, coffee powder P (visible in FIGS. 4 and 5) is obtained with finer grain size and vice versa.

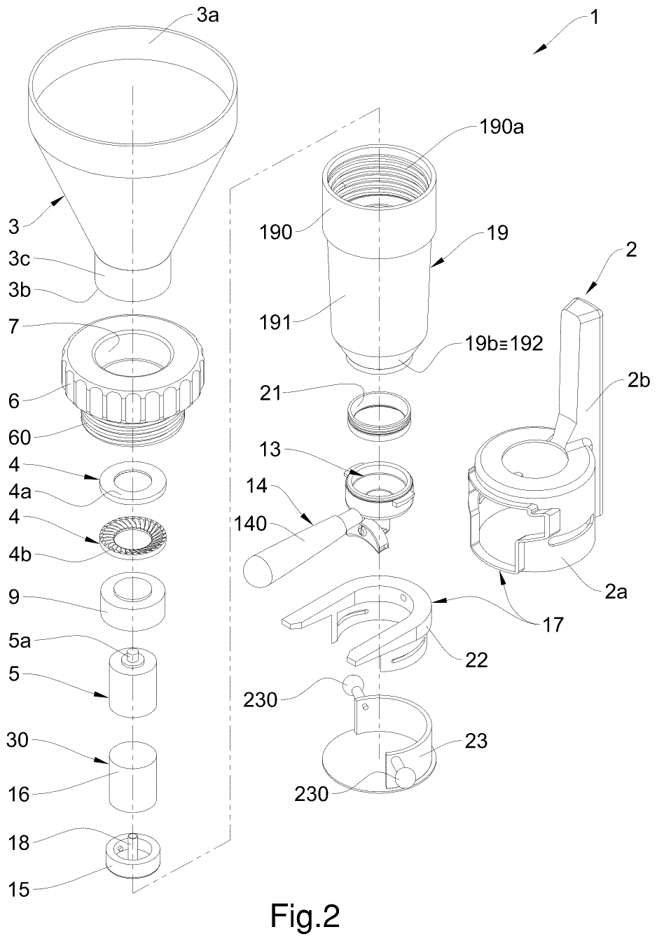

FIG. 2 shows that the hopper 3 is associated with the ring nut 6 by keying an end part 3c of the hopper 3 into a central hole 7 of the ring nut 6.

The end part 3c has a smaller cross section than the inlet port 3a.

As mentioned, the movable grindstone 4b of the grinding assembly 4 is set in rotation by the first motor 5.

In more detail, the first motor 5 is provided with a rotating motor shaft 5a which defines the vertical axis X around which the movable grindstone 4b rotates.

In the embodiment shown in the figures, the rotating motor shaft 5a is advantageously connected to a support 9, on which the movable grindstone 4b is attached.

Since the movable grindstone 4b is locked together with the support 9, then when the latter is set in rotation by the first motor 5, the movable grindstone 4b also rotates together with the support 9.

The fixed grindstone 4a is attached internally and locked together with the ring nut 6.

The appliance 1 according to the invention comprises a first casing 19 and a second casing 20 of tubular conformation and substantially coaxial to the vertical axis X.

The first casing 19 is associated with the holding frame 2; in particular, the first casing 19 comprises an outer side surface which is advantageously associated with the supporting pin 2b.

The second casing 20, on the other hand, is arranged within the first casing 19; conveniently, the second casing 20 is associated with the first casing 19 by means of a supporting arm 11 which joins an inner surface 20a of the first casing 19 with an outer surface 20a of the second casing 20.

The first casing 19 and the second casing 20 are spaced apart from each other by means of a gap defining an annular chamber 10 adapted to receive the coffee powder P ground by the grinding assembly 4 and to convey it towards a filter 13 for coffee machines arranged where a bottom of the annular chamber 10 is located.

The first casing 19, e.g., has the shape of a tube with a profile slightly flared downwards.

Advantageously the first casing 19 also has a lower ending piece 19b of conical shape, which operates as a funnel to concentrate, towards the filter 13, the coffee powder P dropping along the annular chamber 10.

In the particular embodiment shown in the figures, the first casing 19 e.g. comprises:
a first section 190, of cylindrical conformation, which is arranged at the top of the first casing 19 and is provided with an internal thread 190a, on which the ring nut 6 is screwed by means of an external thread 60 formed on the ring nut itself;
a second section 191, joined inferiorly to the first section 190, having a substantially conical profile and converging downwards;
a third section 192, joined inferiorly to the second section 191, having a substantially conical profile and converging downwards with a greater slope than that of the second section 191.

The third section 192 of the first casing 19 defines the aforementioned lower ending piece 19b and terminates in the proximity of the filter 13 fitted into the filter holder 14.

A seal 21 is connected at the lower end of the third section 192 of the first casing 19, which seal is advantageously configured to prevent accidental spilling of the coffee powder P outside the appliance 1.

The second casing 20 conveniently has a cylindrical profile and encloses the first motor 5; in particular, the first motor 5 is arranged within the second casing 20 inferiorly to the grinding assembly 4, which grinding assembly 4 is placed at the top of the second casing 20, outside it.

Advantageously, at least one of either the inner surface 19a of the first casing 19 or the outer surface 20a of the second casing 20, preferably both, is made of a non-stick material, so as to prevent the deposit of coffee powder along the annular chamber 10.

For this purpose, the inner surface 19a of the first casing 19 and/or the outer surface 20a of the second casing 20 can be made non-stick by heat treatment and/or coating, which are known in themselves.

Alternatively, the appliance 1 may provide for the fabrication of a shaped coating layer, having a profile which can match that of the inner surface 19a and/or of the outer surface 20a, which is fabricated separately from the first casing 19 and from the second casing 20 and which is applied to the inner surface 19a and/or to the outer surface 20a during the assembly phase.

Also in accordance with the present invention, the appliance 1 comprises actuating means 30 arranged within the second casing 20 and adapted to move a presser 15 along the vertical axis X at the bottom of the annular chamber 10.

The presser 15 is configured to press the coffee powder P collected in the filter 13, as shown in FIG. 5, and, for this purpose, is conveniently placed where the bottom of the second casing 20 is located, outside it.

In this regard, it is pointed out that the filter 13, and in particular the periphery 13a thereof, is the arrival point of the coffee powder P, where the coffee powder P is conveyed as it drops by gravity along the annular chamber 10, is deflected by the lower ending piece 19b of conical shape, following the direction of the arrows Y as shown in FIGS. 4 and 5, and collects within the filter 13 underneath. This creates, by grinding, a filling of coffee powder P with even thickness in the filter 13 from its periphery 13a towards the center. Then, as a result of the pressing of the coffee powder P by means of the presser 15, the powder is evenly distributed over the entire circular surface of the filter 13.

It is also pointed out that since the coffee powder P flows radially and uniformly (360°) out of the grinding assembly 4 as it enters the annular chamber 10, it ends up to be evenly distributed inside the filter 13 as well.

Conveniently, the actuating means 30 comprise a second motor 16 adapted to operate a linear actuator 18 connected to the presser 15.

By way of non-limiting example only, the linear actuator 18 can be either a cam or a worm screw.

Advantageously, the grinding assembly 4, the first motor 5, the actuating means 30 and the presser 15 are aligned with each other along the vertical axis X, with the grinding assembly 4 arranged on the top, the first motor 5 arranged below the grinding assembly 4, the actuating means 30 arranged below the first motor 5 and the presser 15 arranged below the actuating means 30.

The filter 13 is supported by the filter holder 14 which, in turn, is provided with a handle 140.

The filter holder 14 is intended to be supported by the appliance 1 during grinding and filling the filter 13 with the coffee powder P.

For this purpose, the appliance 1 comprises at least one housing 17 formed in the holding frame 2 and adapted to receive and hold the filter 13 during the grinding and filling operations of the filter 13.

The housing 17 is conveniently obtained in the base 2a.

The housing 17 comprises, e.g., a height-adjustable shaped holding element 22 and a shaped member 23 provided with a pair of knobs 230.

These knobs 230 are used by the user to adjust the height of the shaped holding element 22 of the filter holder 14, as will be better explained below.

To promote the operation thereof, the appliance 1 comprises at least one automatic activation device 24 adapted to automatically activate the first motor 5 when the filter 13 is placed in a predefined position.

The automatic activation device 24 is selected from the list comprising: a pressure activator, an electric contact activator or a photocell activator.

Conveniently, the automatic activation device 24 is positioned where the housing 17 is located and, e.g., is mounted on the shaped holding element 22.

In actual facts, the predefined position wherein the first motor 5 is automatically activated is the position in which the filter 13 and the relevant filter holder 14 are placed in the housing 17; in this position, the automatic activation device 24 detects that the filter 13 and the relevant filter holder 14 are correctly placed on board the appliance 1, i.e., below the annular chamber 10, and activates the first motor 5 to start coffee grinding.

In combination with or as an alternative to the automatic activation device 24, the appliance 1 may comprise a manual activation device, not shown in the figures, which consists, e.g., of a button, a lever or the like; in this case, once the filter 13 and the filter holder 14 are fitted into the housing 17, the first motor 5 and, consequently, the grinding by the grinding assembly 4 turn on only when the user operates the manual activation device.

The turning off of the first motor 5 and the consequent activation of the actuating means 30, on the other hand, preferably occur in a timed manner; in other words, after a predefined time of activation of the first motor 5, which can be set depending on the amount of coffee powder P to be ground (corresponding to the amount of coffee to be loaded into the filter 13), the first motor 5 automatically turns off and, equally automatically, the actuating means 30 are activated to press the coffee powder P into the filter 13.

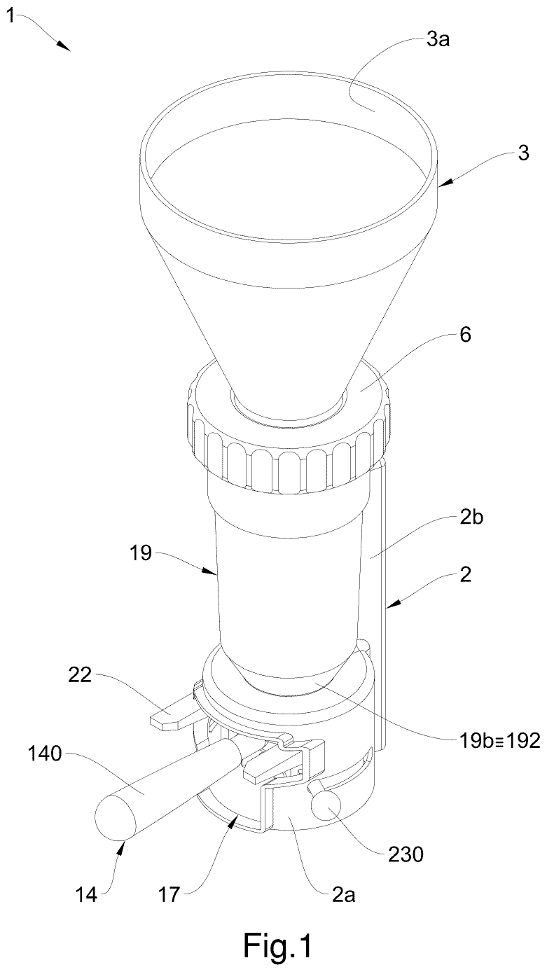

Once assembled into its various components, the appliance 1 has the configuration shown in FIG. 1.

### Embodiments of the Invention

With reference to all the figures, the operation of the appliance 1 is as follows.

First, the user loads the hopper 3 with coffee beans, after pre-setting in advance the desired grain size by manually turning the ring nut 6.

Next, the user inserts the filter 13 into the filter holder 14 and places the filter holder 14 into the housing 17, by adjusting the height thereof by turning the knobs 230.

Upon activation of the first motor 5, which as mentioned can be done automatically (via the automatic activation device 24) or manually (via a button, a lever or the like), the coffee beans conveyed from the hopper 3 to the grinding assembly 4 are ground and reduced into coffee powder P.

The newly generated coffee powder P is partly conveyed by gravity along the annular chamber 10 to the periphery 13a of the filter 13.

In addition to gravity, the fact of conveying the coffee powder P is also facilitated by the movement of the fixed grindstone 4a and of the movable grindstone 4b, which are opposite each other. Such movement of the grindstones 4a and 4b, as well as their vibration, in fact, create a turbulent air flow adapted to promote the conveying of the coffee powder P through the annular chamber 10.

In this way, advantageously, the turbulent air flow due to the movement of the grindstones 4a and 4b and to their vibration prevents the coffee powder from settling along the inner surface 19a of the first casing 19 and the outer surface 20a of the second casing 20, thus promoting a continuous and even dispensing of the coffee powder P towards the filter 13.

In addition, continuous and even dispensing of the coffee powder P throughout the periphery 13a of the filter 13 is promoted:
by the outflow of the coffee powder P from the grinding assembly 4, which occurs radially and 360°;
by the alignment of the grinding assembly 4, of the first motor 5, of the actuating means 30 and of the presser 15 along the single vertical axis X.

Finally, the converging profile of the lower ending piece 19b with conical shape allows the coffee powder P to be conveyed towards the periphery 13a of the filter 13 in the last part of its path.

Next, when the actuating means 30 are operated to move the presser 15, the latter is displaced vertically downwards and presses the coffee powder P present throughout the periphery 13a of the filter 13, thus creating an even layer over the entire surface of the filter 13. In this way, excellent cup coffee can be obtained. Once the coffee powder P has been pressed, the presser 15 returns upwards to its initial home position.

At this point, the user can manually detach the filter holder 14 from the appliance 1 by means of the handle 140 and to connect it to a cup coffee dispensing machine (not visible in the figures).

It is clear from what has been described so far that the objects of the present invention have been achieved.

Advantageously, in fact, the appliance according to the invention allows the coffee powder to flow out radially directly from the grinding assembly through a single annular chamber whose extension peripherally corresponds to that of the first casing, thus resulting in a continuous and even outflow of the powder itself. In the prior art, on the other hand, the coffee outflow occurred from a single spout/channel whose opening, as it was narrow, did not allow for its even dispensing within the filter.

Still advantageously the operator is able to grind and press coffee in one single operation with the appliance according to the invention.

1) Appliance for grinding and filling with coffee powder a filter to be connected to a cup coffee dispensing machine comprising:
a holding frame;
a hopper, arranged superiorly to the holding frame and provided with an inlet port for loading coffee beans and with a discharge port for ejecting said coffee beans;
a grinding assembly, arranged inferiorly to said hopper and in communication with said discharge port, comprising at least one first grindstone and at least one second grindstone opposite each other, at least one of said grindstones, rotating around a vertical axis (X) by means of a first motor;
characterized by the fact that it comprises:
a first casing of tubular conformation associated with said holding frame and substantially coaxial to said vertical axis (X);
a second casing of tubular conformation arranged within said first casing and substantially coaxial to said vertical axis (X), wherein said first casing and said second casing are spaced apart from each other by a gap defining an annular chamber adapted to receive coffee powder (P) ground by said grinding assembly and to convey it to a filter for coffee machines arranged where a bottom of said annular chamber is located;
actuating means arranged within said second casing and adapted to move a presser along said vertical axis (X) at said bottom of the annular chamber, said presser being configured to press said coffee powder (P) collected in said filter.

2) Appliance according to claim 1, wherein said grinding assembly, said first motor, said actuating means and said presser are aligned with each other along said vertical axis.

3) Appliance according to claim 1, wherein said first motor is arranged within said second casing inferiorly to said grinding assembly.

4) Appliance according to claim 1, wherein said actuating means comprise a second motor adapted to operate a linear actuator connected to said presser.

5) Appliance according to claim 1, wherein said second casing is associated with said first casing by means of at least one supporting arm.

6) Appliance according to claim 1, wherein said first casing has a lower ending piece of conical shape.

7) Appliance according to claim 1, wherein at least one of either an inner surface of said first casing or an outer surface of said second casing is made of a non-stick material.

8) Appliance according to claim 1, wherein it comprises at least one housing formed in said holding frame and adapted to receive and hold said filter during grinding and filling the filter with said coffee powder (P).

9) Appliance according to claim 1, wherein it comprises at least one automatic activation device adapted to automatically activate said first motor when said filter is placed in a predefined position.

10) Appliance according to claim 1, wherein said automatic activation device is selected from the list comprising: a pressure activator, an electric contact activator or a photocell activator.
